(19) United States
(12) Patent Application Publication
(10) Pub. No.: US 2026/0253072 A1
(43) Pub. Date: Aug. 27, 2026

(54) PAYMENT TRANSACTIONS ON A DEVICE USING INFORMATION DERIVED FROM THIRD PARTY CREDENTIALS

(71) Applicant: Apple Inc., Cupertino, CA (US)

(72) Inventors: Vamshi Krishna AILENI, San Jose, CA (US); Oren M. ELRAD, Los Gatos, CA (US)

(21) Appl. No.: 19/215,315

(22) Filed: May 21, 2025

Related U.S. Application Data
(60) Provisional application No. 63/761,826, filed on Feb. 21, 2025.

(51) Int. Cl. G06Q 20/40; G06Q 20/42

(52) U.S. Cl. CPC G06Q 20/40; G06Q 20/42

(57) ABSTRACT

A first electronic device may use a transaction authorization derived from a payment credential residing and provisioned on a second electronic device to perform a payment transaction with a merchant system on behalf of the second electronic device. The second electronic device may permit the first electronic device perform the payment transaction using the transaction authorization provided by the second electronic device. A user of the first electronic device may have a merchant account with the merchant system. A user of the second electronic device may utilize benefits (e.g., discounts, promotions) the user of the first electronic device is entitled to through the merchant account, while also gaining benefits (e.g., rewards points) of using the credential via the transaction authorization.

### CROSS REFERENCE TO RELATED APPLICATION(S)

The present application claims the benefit of U.S. Provisional Application No. 63/761,826, entitled “PAYMENT TRANSACTIONS ON A DEVICE USING INFORMATION DERIVED FROM THIRD PARTY CREDENTIALS”, filed Feb. 21, 2025, the entirety of which is incorporated herein for reference.

### TECHNICAL FIELD

This application is directed to using a credential on a device, and more particularly, to a first device using a representation of a credential residing a second device to perform a transaction on the first device.

### BACKGROUND

A user may store a credential corresponding to an account that is associated with and/or managed by the user's electronic device. Using the electronic device, the user may perform a transaction (e.g., purchase an item) using the credential. If another user desires to use the credential, the user may be required provide the user's device to the other user. Alternatively, the user may be required to provide the other user with a credit card, debit card, or the like.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example of a network environment for a payment processing system in which a credential may be shared between devices, in accordance with aspects of the present disclosure.

FIG. 2 illustrates a block diagram of an example electronic device that may be used to provide and/or transact with a credential, in accordance with aspects of the present disclosure.

FIG. 3 illustrates a block diagram of an example electronic device that is configured to provide a transaction authorization, based on a credential stored on the electronic device, to another electronic device, in accordance with aspects of the present disclosure.

FIG. 4 illustrates an example process flow for performing a payment transaction by an electronic device on behalf of a user of another electronic device, in accordance with aspects of the present disclosure.

FIG. 5 illustrates a flow diagram showing an example of a process for performing a transaction via a first user device using a transaction authorization derived from a credential residing on a second user device, in accordance with aspects of the present disclosure.

FIG. 6 illustrates a flow diagram showing an alternate example of a process for performing a transaction via a first user device using a transaction authorization derived from a credential residing on a second user device, in accordance with aspects of the present disclosure.

FIG. 7 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

The present disclosure is directed to using an electronic device to perform a transaction (e.g., payment transaction) with information derived from a credential (e.g., credit card, bank account, etc.) that belongs to a user of another electronic device. For example, a first user device may request use of a payment credential stored on a second user's device to perform a transaction. When the second user approves, the second user's device may provide a transaction authorization to the first user's device, allowing the first user to perform the transaction. The transaction authorization may include information (e.g., cryptographic information) such as an account number associated with the credential, an amount (e.g., maximum amount to be charged, an amount based on one items identified by the first user), and a merchant. The first user device can use the transaction authorization to shop for an item(s) sold by the merchant, place the item(s) in a cart, and pay for the item(s) in the cart. Prior to paying for the item(s), the first user device can send a payment request to the second user device to obtain the transaction authorization from the user of the second user device to use the information derived payment credential residing on the second user's device, while the payment credential itself remains on the second user's device and is not provided to the first user's device. The user of the second user device may also approve and/or authorize the selected item(s) for purchase. In addition to a secure payment transaction, the user of the second user device may also receive discounts and rewards (e.g., credit card points) based on the transaction authorization of the payment credential by the user of the first user device.

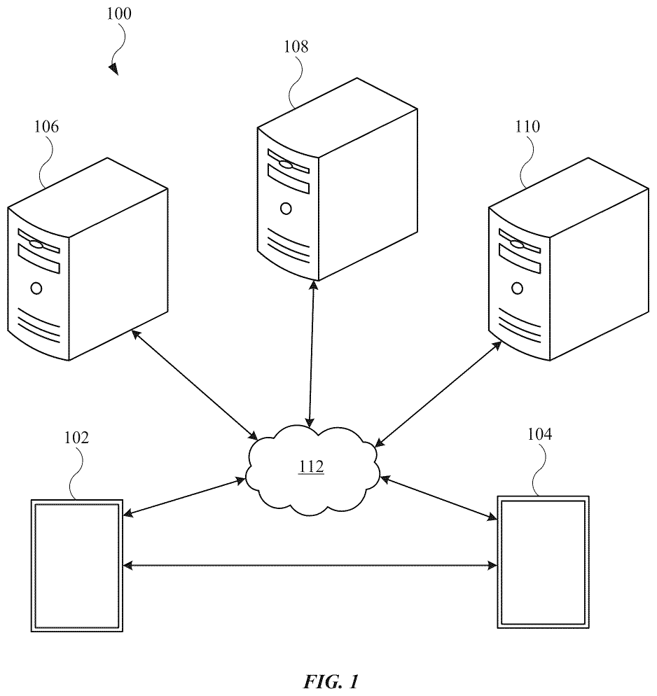

These and other embodiments are discussed below with reference to FIGS. 1-7. However, those skilled in the art will readily appreciate that the detailed description given herein with respect to these Figures is for explanatory purposes only and should not be construed as limiting.

FIG. 1 illustrates an example of a network environment 100 for a system in which a credential may be shared between devices, in accordance with aspects of the present disclosure. Not all of the depicted components may be used in all implementations, however, and one or more implementations may include additional or different components than those shown in FIG. 1. Variations in the arrangement and type of the components may be made without departing from the spirit or scope of the claims as set forth herein. Additional components, different components, or fewer components may be provided.

The network environment 100 may include an electronic device 102, an electronic device 104, a payment server 106, and a financial institution server 108, and a merchant server 110. The network environment 100 may further include a network 112 communicatively (directly or indirectly) coupled with one or more of the electronic device 102, the electronic device 104, the payment server 106, the financial institution server 108, and the merchant server 110. In one or more implementations, the network 112 may be an interconnected network of devices that may include, or may be communicatively coupled to, the Internet. For explanatory purposes, the network environment 100 is illustrated in FIG. 1 as including the electronic device 102, the electronic device 104, the payment server 106, the financial institution server 108, the merchant server 110, and the network 112. However, the network environment 100 may include any number of electronic devices and/or any number of servers communicatively coupled to each other directly or via the network 112.

Each of the electronic devices 102 and 104 may take the form of, for example, a wearable device such as a watch (or smartwatch), a portable computing device (e.g., a smartphone, a tablet device), or any other appropriate device that includes, for example, one or more wireless interfaces, such as WLAN radios, cellular radios, BLUETOOTH® radios, Zigbee radios, near field communication (NFC) radios, and/or other wireless radios. In FIG. 1, by way of example, each of the electronic devices 102 and 104 is depicted as a smartphone.

The payment server 106 may facilitate management of a variety of digital assets for the electronic devices 102 and 104. For example, the payment server 106 may facilitate provisioning a credential of a user on a secure element of the electronic device 104. As a non-limiting example, the credential may be associated with an account (e.g., credit card, debit card, or the like) owned or managed by the user and stored in a digital wallet of the electronic device 104, such as in the form of a credential provisioned on a secure element of the electronic device 104. In one or more implementations, at least one of the payment server 106 or the financial institution server 108 provisions, and/or facilitates provisioning, the credential on the electronic device 104 by, for example, a secure element of the electronic device 104.

In some instances (described below), the electronic device 104 may provide a transaction authorization to the electronic device 102 for the electronic device 102 to perform a transaction on behalf of the electronic device 104 (e.g., a user of the electronic device 104). The transaction authorization may include, for example, information (e.g., cryptographic information) such as an account number and/or other identifier associated with or derived from the credential, an amount (e.g., maximum amount to be charged, an amount based on one items identified by the first user), and/or a merchant identifier, such that the transaction authorization allows for a single-use authorization for the electronic device 102 to perform the transaction. In one or more implementations, the transaction authorization may further include EA nonce and/or additional information derived from the credential and/or corresponding to the transaction. As an example, a user may select via the electronic device 102 one or more items for an order transaction with the merchant server 110 and pay for the one or items of the order transaction using the transaction authorization provided by the electronic device 104. This may require, for example, a request from the electronic device 102 to the electronic device 104 to use information associated with the provisioned credential on the electronic device 104, and authorization/approval by the electronic device 104 (e.g., the user of the electronic device 104) to use the provisioned credential in the form of the transaction authorization on the electronic device 102.

The financial institution server 108 may include a server functioning as a third-party network for a financial institution such as a bank, a virtual bank, a credit union, a credit card vendor, a gift card vendor, an investment firm, or a brokerage account, as non-limiting examples. Generally, the financial institution server 108 may include any entity that holds an account, on behalf of a user (e.g., a user of the electronic device 104)). Additionally, the financial institution server 108 may be used for payment processing for one or more of the electronic devices 102 and 104. Further, a user may interact with the financial institution server 108 by one or more of a software application, or app, running on at least one of the electronic device 102 or the electronic device 104. It should be noted that the information provided in the transaction authorization is sufficient for the payment server 106 and the financial institution server 108 to approve and complete the transaction initiated by the electronic device 102.

The merchant server 110 may include a server for a merchant system (e.g., retail business) that offers various items for sale. As an example, the electronic device 102 may purchase items provided by the merchant server 110. The electronic device 104 may notify the electronic device 102 as to which item(s) are requested for purchase, and provide the transaction authorization to the electronic device 102 to purchase the item(s). This will be discussed in further detail below.

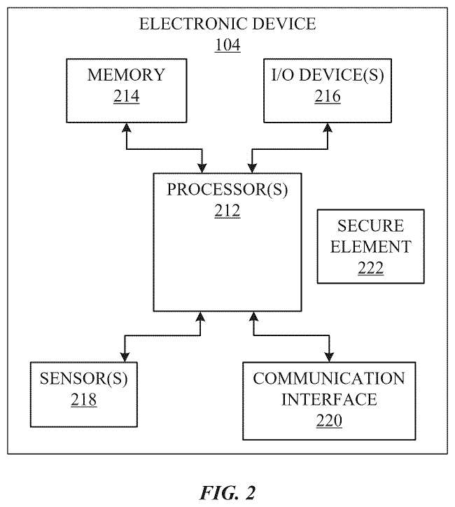

FIG. 2 illustrates a block diagram of an example of an electronic device 104 that may be used to provide and/or transact with a credential, in accordance with aspects of the present disclosure. The electronic device 104 shown in FIG. 2 may be implemented in any other electronic device for use with the subject technology. Variations in the arrangement and type of the components may be made without departing from the spirit or scope of the claims as set forth herein. Additional components, different components, or fewer components may be provided. Also, the electronic device 102 (both shown in FIG. 1) may include any components and associated features shown and/or described herein for the electronic device 104.

The electronic device 104 may include one or more processors 212, a memory 214, one or more input-output devices 216 (I/O devices(s)), one or more sensors 218, a communication interface 220, and a secure element 222. The one or more processors 212 may include a central processing unit, a graphics processing unit, one or more microcontrollers, or a combination thereof. Further, the one or more processors 212 may include suitable logic, circuitry, and/or code that enable processing data and/or controlling operations of the electronic device 104. In this regard, the one or more processors 212 may be enabled to provide control signals to various other components of the electronic device 102. The one or more processors 212 may also control transfers of data between various portions of the electronic device 104. The one or more processors 212 may further implement an operating system or may otherwise execute code to manage operations of the electronic device 104. In one or more implementations, the one or more processors 212 may include a secure element 222 and/or a secure enclave processor. The one or more processors 212 are communicatively coupled to the various components shown in FIG. 2.

The memory 214 may include suitable logic, circuitry, and/or code that enable storage of various types of information such as received data, generated data, code, and/or configuration information. The memory 214 may include volatile memory (e.g., random access memory (RAM)) and/or non-volatile memory (e.g., read-only memory (ROM), flash, and/or magnetic storage). In one or more implementations, the memory 214 may store user account data, and any other data generated in the course of performing the processes described herein.

The one or more input-output devices 216 may include a display. In one or more implementations, the display includes a capacitive touch input display, thus allowing the user to interact with the electronic device 104 by a touch input or gesture to the display. Additionally, the one or more input-output devices 216 may include one or more buttons, which may be actuated by a user of the electronic device 104. The one or more input-output devices 216, while taking the form of a display and/or buttons, may be used to provide an input to the one or more processors 212 in order to, for example, initiate a payment through a payment provider. Further, the one or more input-output devices 216 may include an audio module (e.g., speaker) designed to convert electrical signals into soundwaves in the form of audible sound.

The one or more sensors 218 may include one or more microphones and/or cameras. The microphones may obtain audio signals, such as voice commands from a user to initiate or authorize or request a transaction using information derived from a credential. For example, the microphones may obtain audio of the user reading a passphrase or authentication code. The cameras may be used to capture images corresponding to identity data and/or information derived from credentials.

The communication interface 220 may include suitable logic, circuitry, and/or code that enables wired or wireless communication, such as between the electronic device 104 and the network 112 (shown in FIG. 1). The communication interface 220 may include, for example, one or more of a BLUETOOTH® communication interface, an NFC interface, a Zigbee communication interface, a WLAN communication interface, a Universal Serial Bus (USB) communication interface, a cellular interface, or generally any communication interface. Accordingly, the communication interface 220 may establish a radio network, allowing the electronic device 104 to communicate with another device (e.g., the electronic device 102 shown in FIG. 1).

The secure element 222 may include suitable logic, circuitry, and/or code that enables protection from unauthorized access and hacking attempts. The secure element 222 is physically and programmatically isolated from the processors 212. The secure element 222 may store and/or process passwords, codes, biometric data (e.g., fingerprint data), and/or payment information, as non-limiting examples. Additionally, the secure element 222 may allow access from applications running on the electronic device 104, such as a digital wallet that stores a credential. Further, a credential may be provisioned on the secure element 222.

In one or more implementations, the one or more processors 212, the memory 214, the one or more input-output devices 216, the one or more sensors 218, the communication interface 220, the secure element 222, and/or one or more portions thereof may be implemented in software (e.g., subroutines and code), may be implemented in hardware (e.g., an Application Specific Integrated Circuit (ASIC)), a Field Programmable Gate Array (FPGA), a Programmable Logic Device (PLD), a controller, a state machine, gated logic, discrete hardware components, or any other suitable devices) and/or a combination of both.

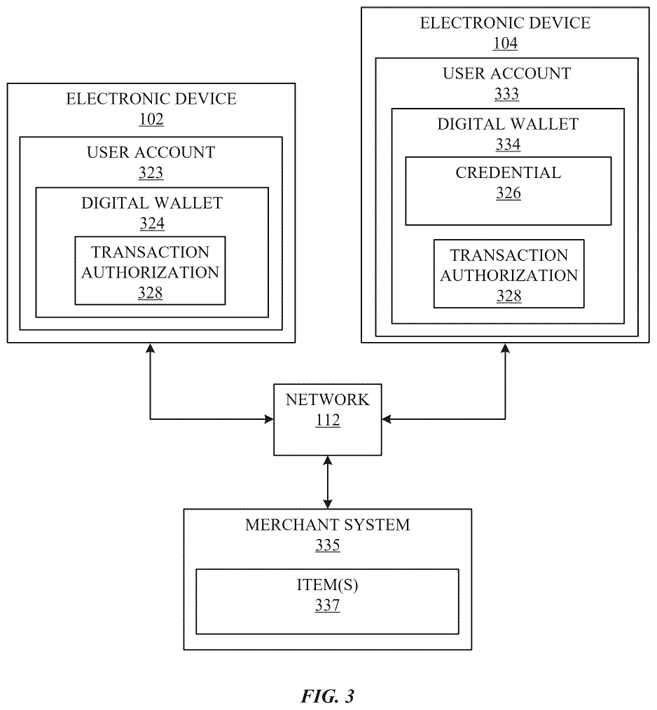

FIG. 3 illustrates a block diagram of an example of an electronic device 104 providing a transaction authorization, based on a credential 326 stored on the electronic device 104, to an electronic device 102, in accordance with aspects of the present disclosure. As shown, the electronic device 102 and the electronic device 104 may include a user account 323 and a user account 333, respectively. The user account 323 and the user account 333 may include digital wallet 324 and a digital wallet 334, respectively. Each of the digital wallets 324 and 334 may store one or more credentials for performing a transaction. For example, the electronic device 104 may store the credential 326 on the digital wallet 334. Accordingly, the credential 326 may be associated with the electronic device 104. Further, the credential 326 may be provisioned on a secure element (e.g., secure element 222 shown in FIG. 2) of the electronic device 104.

In one or more implementations, the electronic device 104 generates a transaction authorization 328 derived from the credential 326. The electronic device 102 may obtain the transaction authorization 328 from the electronic device 104 via the network 112 and store the transaction authorization 328 in, for example, the digital wallet 324. The transaction authorization 328 may subsequently be used by the user of the electronic device 102. A user of the electronic device 102 may use the transaction authorization 328, which is a representation of the credential 326, which resides and remains on the electronic device 104, to perform a payment transaction on the electronic device 102. For example, the electronic device 102 may retrieve, via merchant system 335, one or more items 337 provided by the merchant system 335 for purchase. The merchant system 335 may be networked with a merchant server (e.g., merchant server 110 shown in FIG. 1). The electronic device 102 may request use of the transaction authorization 328 from the electronic device 104 to perform a transaction with the merchant system 335 by, for example, placing an order for the one or more items 337. Based on providing the transaction authorization 328, the user of electronic device 104 may approve a single-use payment transaction for one or more items, while the payment transaction is routed through the electronic device 102.

Additionally, the user of the electronic device 102 may have an account established with the merchant system 335 and communicate with the merchant system via the network 112. In this regard, a user of the electronic device 102 may receive from the merchant system 335 certain benefits (e.g., discounts, promotions), as non-limiting examples. When the electronic device 102 performs the transaction using the transaction authorization 328, the user of the electronic device 104 may utilize the same benefits from the merchant system 335 to which the user of the electronic device 102 is entitled. Moreover, the user of the electronic device 104 may earn rewards (e.g., points) when the credential 326 is utilized via the transaction authorization 328.

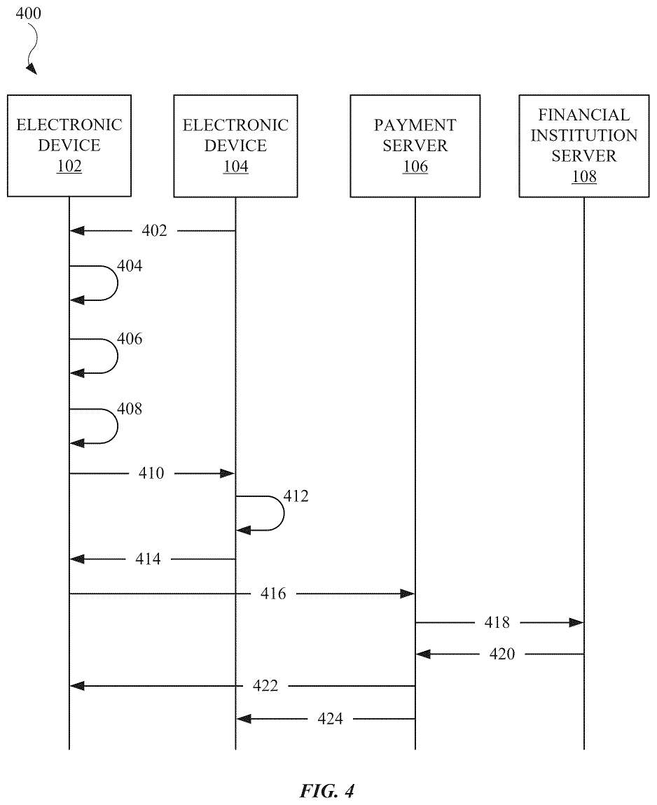

FIG. 4 illustrates an example of a process flow 400 for performing a payment transaction by an electronic device 102 on behalf of a user of an electronic device 104, in accordance with aspects of the present disclosure. At step 402, the electronic device 102 (e.g., first user device) obtains a request from the electronic device 104 (e.g., second user device) with order information for placing an order, which may be conducted on the electronic device 102 via a user account of a user of the electronic device 102. In one or more implementations, the request is an out-of-band request. The order information may include one or more items (e.g., one or more items 337 shown in FIG. 3). In one or more implementations, the user of the electronic device 102 places the one or more items corresponding to the order information into a cart (e.g., online cart) that is provided via a merchant system (e.g., merchant system 335 shown in FIG. 3). Further, the user of the electronic device 102 may establish an account (or have an established account) with the merchant system. In this regard, the user of the electronic device 102 may be entitled to certain benefits (e.g., discounts) provided by the merchant system.

Using one or more input-output devices (e.g., one or more input-output devices 216), a user may initiate an order via the electronic device 102 based on the order information provided by the electronic device 104. For example, the user may add one or more items (based on the order information) to a cart provided by a web page or the software application provided in part by a merchant or business that sells the one or more items, and proceed to a checkout of the web page or the software application.

At step 404, the electronic device 102 provides a list of options (e.g., transaction options to a user of the electronic device 102) for completing the transaction. For example, the electronic device 102 may provide a list of different payment options for completing the transaction. The list of different payment options may include, for example, a transaction authorization provided by the electronic device 104 based on a credential that has been provisioned on the electronic device 104 and may also include an option to request a transaction authorization from another user.

In one or more implementations, the option to request a transaction authorization from another user may present a list of user names and/or identifiers corresponding to contacts of the user of the electronic device 102. The list may be filtered to only include contacts who have at least one payment credential provisioned on their respective electronic device. In this manner, the subject system improves device and/or network usage by preventing the user of the electronic device 102 from requesting that another user provide a transaction authorization based on a payment credential for a given transaction if the other user does not have any payment credentials provisioned on their respective electronic device(s).

For example, the payment server 106 may store an indication of which electronic devices have payment credentials provisioned thereon. The indication may be received and/or stored, for example, during the provisioning process and may be stored in association with an identifier of the electronic device on which the credential was provisioned and/or an identifier of the user account associated with such an electronic device.

Thus, the electronic device 102 can receive, from the payment server 106, an indication of whether each of the contacts of the user of the electronic device 102 have at least one payment credential provisioned on their respective electronic devices. In one or more implementations, the electronic device 102 of the user can receive such an indication directly from the electronic devices of the contacts of the user, such as in conjunction with messaging with the electronic devices of the contacts. The indication may be received transparently to the user of the electronic device 102.

In one or more implementations, the option to request a transaction authorization based on a credential from another user may allow the user of the electronic device 102 to input a communication identifier for contacting another user to request the use of their credential, via a transaction authorization derived from the credential, for the transaction. The communication identifier may be for example, an identifier of the other user, such as an email address and/or an identifier of an electronic device of the other user, such as a telephone number. The electronic device 102 may utilize the communication identifier to establish communication with the other electronic device in order to request a transaction authorization derived from a payment credential provisioned on the other electronic device.

In one or more implementations, if the request received at step 402 includes an indication that a credential (e.g., payment credential) is available for use by the electronic device 102, the option to request a transaction authorization from another user may be populated by default with a user identifier corresponding to the user of the electronic device 104.

At step 406, the user or account holder of the electronic device 104 is selected to perform the transaction (e.g., to purchase the one or more items). A user may select the user via the electronic device 102 by, for example, selecting the user presented on an I/O device (e.g., a display) of the electronic device 102. In one or more implementations, the electronic device 102 generates a payment request (e.g., payment sheet) that includes the one or more items to be purchased using a derived version of the credential provided by the electronic device 104.

At step 408, the electronic device 102 adds the information of the user of the electronic device 104 to the payment request. For example, the user of the electronic device 102 may add the address and/or other contact information of the user of the electronic device 104, thus allowing the one or more items to be shipped to the user of the electronic device 104.

At step 410, the electronic device 102 sends the payment request to the electronic device 104. The payment request may be sent over a secure channel, such as an identity service (e.g., IDS) messaging channel. The payment request may include a binary large object (BLOB) with a request to use the credential stored on the electronic device 104 to authorize a transaction with a merchant system (e.g., merchant system 335 shown in FIG. 3). The payment request may include information (e.g., cryptographic information), payment information (e.g., maximum amount to be charged, an amount based on one items identified by the first user), order information (e.g., the one or more items to be purchased), and the merchant (e.g., associated with the merchant system), each of which is available for a user of the electronic device 104 to review. The payment request may be presented on an I/O device (e.g., a display) of the electronic device 104. The payment request may be encrypted by the electronic device 102 and subsequently decrypted by the electronic device 104.

At step 412, the payment request is authorized by the electronic device 104. In one or more implementations, the user of the electronic device 104 reviews the payment request and authorizes payment, using the credential generated by a secure element of the electronic device 104, of the one or more items associated with the payment request. The electronic device 104 may generate a transaction authorization, e.g., based at least in part on the credential, for use by the electronic device 102 to perform the requested payment transaction.

At step 414, the electronic device 104 communicates authorization of the payment request to the electronic device 102, including the authorization of the payment information and/or the order information. The electronic device 104 may re-encrypt the payment request with the transaction authorization. In one or more implementations, a user of the electronic device 104 may use the electronic device 104 to modify the order information. A modification may include adding an item(s) to the one or more items, or removing an item(s) from the one or more items. When a modification occurs, the order information may be updated prior to proceeding with the transaction.

At step 416, the electronic device 102 sends the re-encrypted payment request to the payment server 106. The re-encrypted payment request may include the transaction authorization associated with the credential provided by the electronic device 104 to the payment server 106. Accordingly, the payment request provided by the electronic device 102 to the payment server 106 may provide an indication that the transaction authorization is derived from the credential, still residing on the electronic device 104, is intended for use to pay for the one or more items. Further, the payment request may indicate the transaction authorization is provided by the electronic device 104 (e.g., based on a payment credential stored on a secure element of the electronic device 104). In one or more implementations, the payment server 106 and not the electronic device 102 may decrypt the re-encrypted transaction authorization provided by the electronic device 104. Moreover, the payment request provided by the electronic device 102 may indicate to the payment server 106 that the transaction authorization provided by the electronic device 104 is a single-use authorization for a particular transaction (e.g., to pay for the selected one or more items). In this regard, in one or more implementation, the electronic device 102 may add/modify an unencrypted header/metadata associated with the re-encrypted transaction authorization and then forward to the payment server 106. The payment server 106 may use the transaction authorization to process the payment request.

At step 418, the payment server 106 sends the payment request to the financial institution server 108. The payment server 106 may decrypt the encrypted payment request (e.g., re-encrypted payment request provided by the electronic device 104) and send the payment information to the financial institution server 108 to perform the payment. The financial institution server 108 may authorize the payment request.

At step 420, the financial institution server 108 provides a notification to the payment server 106 indicating the payment transaction was successful. At step 422, the payment server 106 provides a payment confirmation to the electronic device 102, which may include a notification to the electronic device 102 indicating the payment transaction was successful. At step 424, the payment server 106 provides a provides a payment confirmation to the electronic device 104, which may include a notification to the electronic device 104 indicating the payment transaction was successful.

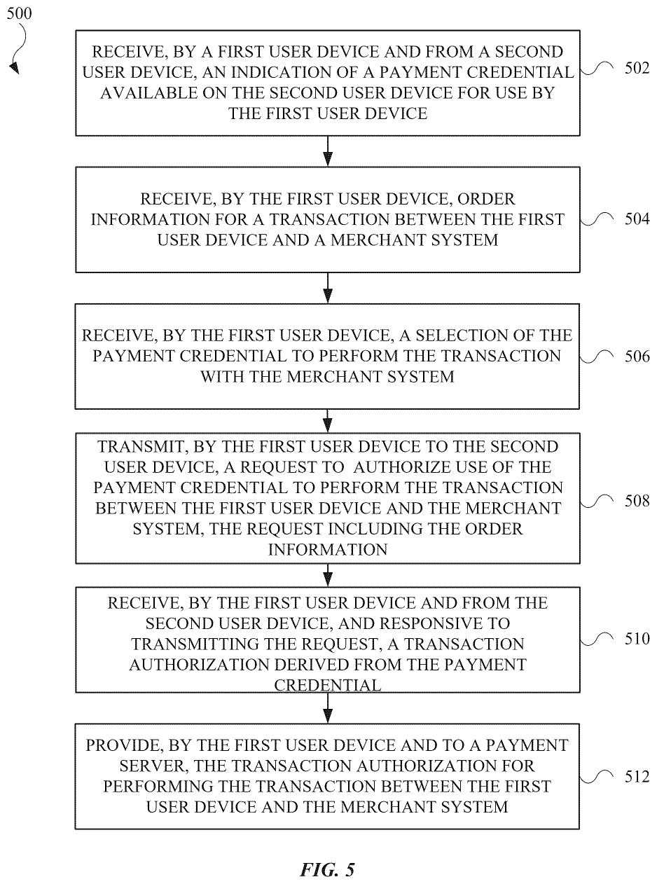

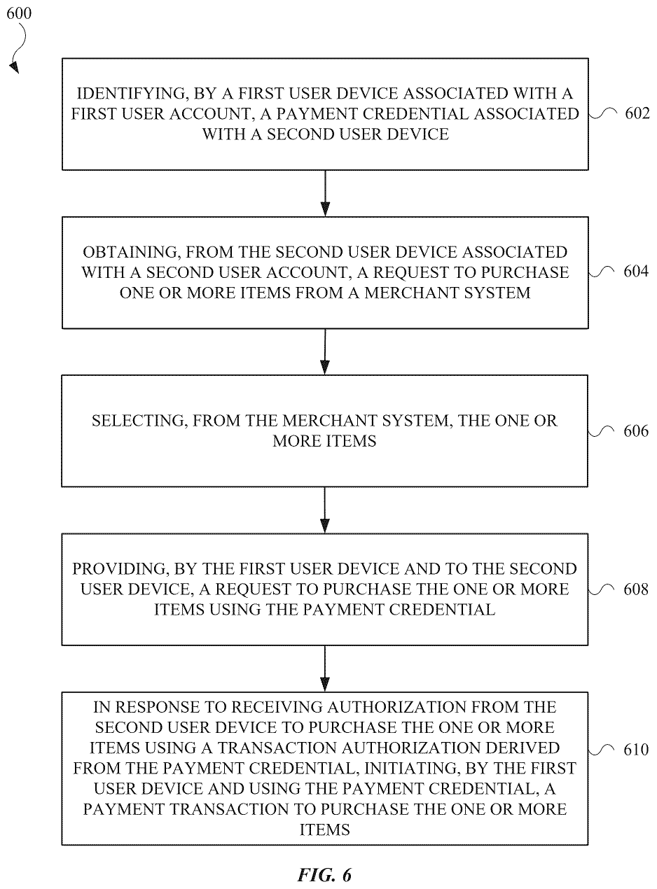

FIG. 5 and FIG. 6 illustrate flow diagrams showing examples of one or more processes for performing a transaction via a first user device using a transaction authorization derived from a credential residing on a second user device, in accordance with implementations of the subject technology. One or more electronic devices (e.g., electronic devices 102 and 104) may be used in part to conduct one or more steps of the example processes. For explanatory purposes, the respective processes shown in FIGS. 5 and 6 are primarily described herein with reference to the electronic devices 102 and 104, which may include a smartphone. However, the respective processes shown in FIGS. 5 and 6 are not limited to the electronic devices 102 and 104, and one or more blocks (or operations) of the respective processes may be performed by one or more other components of other suitable apparatuses, devices, or systems. Further for explanatory purposes, some of the blocks of the respective processes are described herein as occurring in serial, or linearly. However, multiple blocks of the respective processes may occur in parallel. In addition, the blocks of the respective processes need not be performed in the order shown and/or one or more blocks of the respective processes need not be performed and/or can be replaced by other operations.

FIG. 5 illustrates a flow diagram showing an example of a process 500 for performing a transaction via a first user device using a transaction authorization derived from a credential residing on a second user device, in accordance with aspects of the present disclosure.

At block 502, a first user device (e.g., electronic device 102 shown in FIG. 4) receives, from a second user device (e.g., electronic device 104 shown in FIG. 4) and/or from the payment server 106, an indication of a payment credential (e.g., credential 326 shown in FIG. 3) available on the second user device for use by the first user device.

At block 504, the first user device receives order information for a transaction between the first user device and a merchant system (e.g., merchant system 335 shown in FIG. 3). A user of the first user device may browse the merchant system via a software application on an electronic device (e.g., electronic device 102 shown in FIG. 4) to select one or more items from the merchant system. The first user may log in to a user account established via the merchant system to take an advantages of discounts or other benefits provided to the user via the merchant system. Alternatively, in one or more implementations, the order information (e.g., what the second user desires to order through a merchant system) is provided via the second user device such as through an out-of-band channel, e.g., a voice channel, a messaging channel, and the like. In this regard, the order information may include one or more items requested by a user of the second user device for purchase on the first user device.

At block 506, the first user device receives a selection of the payment credential to perform the transaction with the merchant system. The payment credential may be part of a list of optional credentials on, for example, the second user device that is visible to a user of the first user device.

At block 508, the first user device transmits to the second user device a request to authorize use of the payment credential to perform the transaction between the first user device and the merchant system. The request may include the order information. Additionally, the request may include the cost, or amount to be charged, for the one or more items of the order information.

At block 510, in response to transmitting the request, the first user device receives from the second user device a transaction authorization derived from the payment credential. The payment credential may be stored on a secure element (e.g. secure element 222 shown in FIG. 2) of the electronic device 104.

At block 512, the first user device provides to a payment server (e.g., payment server 106 shown in FIG. 4) the transaction authorization for performing the transaction between the first user device and the merchant system. In this regard, the first user device may conduct the transaction on behalf of the second user device using the transaction authorization derived from the payment credential, while the payment credential resides on the second user device and is not transferred to the first user device.

FIG. 6 illustrates a flow diagram showing an alternate example of a process 600 for performing a transaction via a first user device using a transaction authorization derived from a credential residing on a second user device, in accordance with aspects of the present disclosure.

At block 602, a first user device (e.g., electronic device 102 shown in FIG. 4) associated with a first user account (e.g., user account 323 shown in FIG. 3) identifies a payment credential (e.g., credential 326 shown in FIG. 3) associated with a second user device (e.g., electronic device 104 shown in FIG. 4).

At block 604, the first user device obtains, from the second user device associated with a second user account (e.g., user account 333 shown in FIG. 3), a request to purchase one or more items (e.g., one or more items 337 shown in FIG. 3) from a merchant system (e.g., merchant system 335 shown in FIG. 3).

At block 606, the one or more items from the merchant system is selected. In one or more implementations, the one or more items are selected for purchase by a user of the first user device and an information associated with the selected one or items may be provided to the user of the second user device for review. Alternatively, in one or more implementations, the one or more items are selected for purchase by a user of the second user device and transmitted to a user of the first user device, such as in the form of a request to the user of the first user device to purchase the one or more items, allowing the first user device to subsequently carry out a transaction to purchase the one or more items on behalf of the user of the second user device.

At block 608, a request is provided, by the first user device and to the second user device, to purchase (by the first user device) the one or more items using the payment credential (or a derivation thereof). The request may include a request for authorization by the second user device for the first user device to utilize a derivation of the payment credential to purchase the one or more items.

At block 610, in response to receiving authorization from the second user device to purchase the one or more items using the payment credential, the first user device uses a transaction authorization derived from the payment credential to initiate a payment transaction to purchase the one or more items. The first user device may subsequently communicate with a payment server (e.g., payment server 106 shown in FIG. 4) and a financial institution server (e.g., financial institution server 108 shown in FIG. 4).

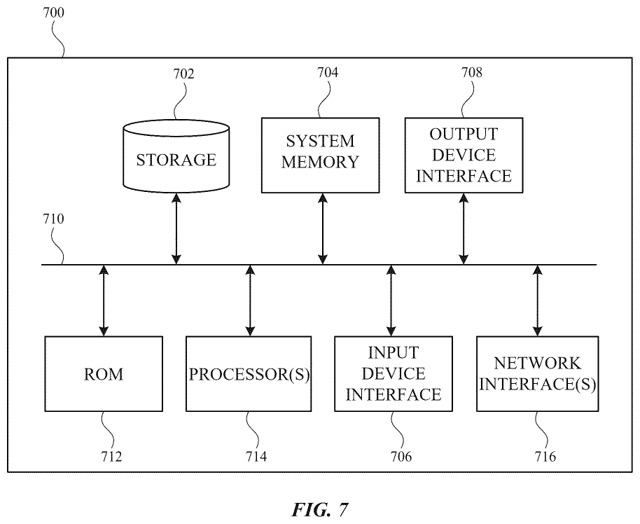

FIG. 7 illustrates an electronic system 700 with which one or more implementations of the subject technology may be implemented. The electronic system 700 can be, and/or can be a part of, the electronic device 102 or the electronic device 104 as shown in FIG. 1. The electronic system 700 may include various types of computer readable media and interfaces for various other types of computer readable media. The electronic system 700 includes a bus 710, one or more processing units 714, a system memory 704 (and/or buffer), a ROM 712, a permanent storage device 702, an input device interface 706, an output device interface 708, and one or more network interfaces 716, or subsets and variations thereof.

The bus 710 collectively represents all system, peripheral, and chipset buses that communicatively connect the numerous internal devices of the electronic system 700. In one or more implementations, the bus 710 communicatively connects the one or more processing units 714 with the ROM 712, the system memory 704, and the permanent storage device 702. From these various memory units, the one or more processing units 714 retrieves instructions to execute and data to process in order to execute the processes of the subject disclosure. The one or more processing units 714 can be a single processor or a multi-core processor in different implementations.

The ROM 712 stores static data and instructions that are needed by the one or more processing units 714 and other modules of the electronic system 700. The permanent storage device 702, on the other hand, may be a read-and-write memory device. The permanent storage device 702 may be a non-volatile memory unit that stores instructions and data even when the electronic system 700 is off. In one or more implementations, a mass-storage device (such as a magnetic or optical disk and its corresponding disk drive) may be used as the permanent storage device 702.

In one or more implementations, a removable storage device (such as a flash drive, and its corresponding disk drive) may be used as the permanent storage device 702. Like the permanent storage device 702, the system memory 704 may be a read-and-write memory device. However, unlike the permanent storage device 702, the system memory 704 may be a volatile read-and-write memory, such as random access memory. The system memory 704 may store any of the instructions and data that one or more processing units 714 may need at runtime. In one or more implementations, the processes of the subject disclosure are stored in the system memory 704, the permanent storage device 702, and/or the ROM 712 (which are each implemented as a non-transitory computer-readable medium). From these various memory units, the one or more processing units 714 retrieves instructions to execute and data to process in order to execute the processes of one or more implementations.

The bus 710 also connects to the input device interface 706 and output device interface 708. The input device interface 706 enables a user to communicate information and select commands to the electronic system 700. Input devices that may be used with the input device interface 706 may include, for example, alphanumeric keyboards and pointing devices (also called “cursor control devices”). The input device interface 706 may enable, for example, the display of images generated by electronic system 700. Output devices that may be used with the input device interface 706 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

The bus 710 also couples the electronic system 700 to one or more networks and/or to one or more network nodes, such as the electronic devices 102 and 104 shown in FIG. 1, through the one or more network interfaces 716. In this manner, the electronic system 700 can be a part of a network of computers (such as a LAN, a wide area network (“WAN”), or an Intranet, or a network of networks, such as the Internet. Any or all components of the electronic system 700 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, and/or any other optical or magnetic media. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

As described above, one aspect of the present technology is the gathering and use of data available from specific and legitimate sources for performing a transaction via a first user device using a transaction authorization derived from a credential provided by a second user device. The present disclosure contemplates that in some instances, this gathered data may include personal information data that uniquely identifies or can be used to identify a specific person. Such personal information data can include audio data, voice data, demographic data, location-based data, online identifiers, telephone numbers, email addresses, home addresses, encryption information, data or records relating to a user's health or level of fitness (e.g., vital signs measurements, medication information, exercise information), date of birth, or any other personal information.

The present disclosure recognizes that the use of personal information data, in the present technology, can be used to the benefit of users. For example, the personal information data can be used for performing a transaction via a first user device using a transaction authorization derived from a credential provided by a second user device.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of performing a transaction via a first user device using a transaction authorization derived from a credential provided by a second user device, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving, by a first user device and from a second user device, an indication of a payment credential available on the second user device for use by the first user device;
receiving, by the first user device, order information for a transaction between the first user device and a merchant system;
receiving, by the first user device, a selection of the payment credential to perform the transaction with the merchant system;
transmitting, by the first user device to the second user device, a request to authorize use of the payment credential to perform the transaction between the first user device and the merchant system, the request including the order information;
receiving, by the first user device and from the second user device, and responsive to transmitting the request, a transaction authorization derived from the payment credential; and
providing, by the first user device and to a payment server, the transaction authorization for performing the transaction between the first user device and the merchant system.

2. The method of claim 1, further comprising subsequent to providing the transaction authorization for performing the transaction, receiving, from the payment server, a payment confirmation.

3. The method of claim 1, further providing, by the first user device, an option to select the payment credential.

4. The method of claim 1, wherein the transaction authorization is encrypted.

5. The method of claim 1, further comprising receiving, from the first user device and by the second user device, authorization to perform the transaction.

6. The method of claim 1, further comprising receiving, from the second user device, a request to purchase one or more items associated with the order information.

7. The method of claim 1, further comprising associating the payment credential with a contact.

8. The method of claim 1, wherein the order information comprises an amount to be charged using the transaction authorization.

9. The method of claim 1, further comprising receiving, by the first user device and from the second user device, authorization to modify the order information.

10. A non-transitory computer-readable medium, comprising:
computer-readable instructions that, when executed by a processor, cause the processor to perform one or more operations comprising:
identifying, by a first user device associated with a first user account, a payment credential associated with a second user device;
obtaining, from the second user device associated with a second user account, a request to purchase one or more items from a merchant system;
selecting, from the merchant system, the one or more items;
providing, by the first user device and to the second user device, a request to purchase the one or more items using the payment credential; and
in response to receiving authorization from the second user device to purchase the one or more items using the payment credential, initiating, by the first user device and using a transaction authorization derived from the payment credential, a payment transaction to purchase the one or more items.

11. The non-transitory computer-readable medium of claim 10, further comprising receiving, by the first user device and from the second user device, the transaction authorization.

12. The non-transitory computer-readable medium of claim 11, wherein the transaction authorization is associated with the second user account.

13. The non-transitory computer-readable medium of claim 10, further comprising subsequent to initiating the payment transaction, providing, by the first user device and to a payment server, the transaction authorization.

14. The non-transitory computer-readable medium of claim 13, further comprising subsequent to providing the transaction authorization, receiving, by the first user device and from the payment server, a payment confirmation.

15. The non-transitory computer-readable medium of claim 14, further comprising subsequent to providing the payment confirmation to the payment server, receiving, from the payment server, an indication that the payment transaction is completed.

16. The non-transitory computer-readable medium of claim 10, f further providing, by the first user device, an option to select the payment credential.

17. A system, comprising:
a memory; and
a processor configured to:
receive, from a user device, an indication of a payment credential available on the user device;
receive, from the user device, order information for a transaction between with a merchant system;
receive a selection of the payment credential to perform the transaction with the merchant system;
transmit, to the user device, a request to authorize use of the payment credential to perform the transaction between the first user device and the merchant system, the request including the order information;
receive, from the user device, and responsive to transmitting the request, a transaction authorization derived from the payment credential; and
provide, to a payment server, the transaction authorization for performing the transaction between the system and the merchant system.

18. The system of claim 17, wherein the processor is further configured to subsequent to providing the transaction authorization for performing the transaction, receive, from the payment server, a payment confirmation.

19. The system of claim 17, wherein the processor is further configured to receive, from the user device, a request to purchase one or more items associated with the order information.

20. The system of claim 17, wherein the processor is further configured to receive, from the user device, authorization to modify the order information.
